(19) United States
(12) Patent Application Publication
(10) Pub. No.: US 2010/0110494 A1
(43) Pub. Date: May 6, 2010

(54) IMAGE FORMING METHOD AND APPARATUS USING PORTABLE STORAGE MEDIUM

(75) Inventors: Seong-kyoo PARK, Hwaseong-si (KR); Jong-Kwon Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/536,621

(22) Filed: Aug. 6, 2009

(30) Foreign Application Priority Data
Oct. 30, 2008 (KR) 10-2008-0107081

(51) Int. Cl. G06K 15/00

(52) U.S. Cl. 358/1.16

(57) ABSTRACT

An image forming method, and an image forming apparatus to perform same, including connecting a portable storage medium to the image forming apparatus, selecting at least one file stored in the portable storage medium, disconnecting the portable storage medium from the image forming apparatus, and performing a job corresponding to the at least one selected file in response to the portable storage medium being disconnected from the image forming apparatus.

### CROSS-REFERENCE TO RELATED APPLICATIONS

This application claims the benefit under 35 U.S.C. §119(a) of Korean Patent Application No. 10-2008-0107081, filed on Oct. 30, 2008, in the Korean Intellectual Property Office, the disclosure of which is incorporated herein by reference in its entirety.

### BACKGROUND

1. Field of the Invention

The present general inventive concept relates to an image forming method and an image forming apparatus using a portable storage medium, and, more particularly, to an image forming method and an image forming apparatus to print, transmit, email, and/or fax a file stored in a portable storage medium more conveniently, and a recording medium storing a program to execute the image forming method.

2. Description of the Related Art

Thanks to the development of electronic technology, various electronic devices have been developed and have become widespread. One such example of the electronic devices is an image forming apparatus.

The electronic device referred to as an image forming apparatus is an apparatus that generates image data by directly scanning an image from a document, such as operations performed by a scanner or a photocopier, or by indirectly receiving image data through a telephone network or receiving data from a host computer through a local/network interface like a facsimile machine or a printer. The image data generated may generally be printed on a recording medium, such as paper, or stored to a portable storage medium.

A conventional image forming apparatus may be adapted to be connected to the portable storage medium such as a universal serial bus (USB) memory or a memory card.

Accordingly, a user is able to directly transmit a file stored in the portable storage medium to the image forming apparatus without using an external host device, so that the user can promptly print the file, email the file to an external host device, transmit the file to a file transfer protocol (FTP) sever, or fax the file to a facsimile machine at a receiving end.

A user frequently uses such a portable medium due to the easy portability of the portable medium. However, a user may forget to disconnect the portable storage medium from the image forming apparatus after printing a file stored in the portable storage medium. In this case, the user may lose the portable storage medium, and there may also be a security problem regarding the file stored in the portable storage medium. As a result, the user may suffer unwanted consequences of such an error.

### SUMMARY

Example embodiments of the present general inventive concept provide an image forming method and an image forming apparatus which are capable of preventing the loss of a portable storage medium and a recording medium storing a program to execute the image forming method.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image forming method of an image forming apparatus using a portable storage medium, the method including connecting the portable storage medium to the image forming apparatus, selecting at least one file stored in the portable storage medium, disconnecting the portable storage medium from the image forming apparatus, and performing a job corresponding to the at least one selected file in response to the portable storage medium being disconnected from the image forming apparatus.

The image forming method may further include converting the at least one selected file into job data.

The image forming method may further include copying the at least one selected file into a storage unit of the image forming apparatus, and the performing of the job may include converting the at least one selected file into job data.

The image forming method may further include outputting a message to request a disconnection of the portable storage medium prior to performing the job corresponding to the at least one selected file.

The image forming method may further include displaying an error message in response to the portable storage medium not being disconnected from the image forming apparatus after a predetermined time.

The portable storage medium may include at least one memory device connectible to a USB port of the image forming apparatus, at least one memory card connectible to a memory slot of the image forming apparatus, or a combination thereof.

The job may include at least one of a printing job, a faxing job, an emailing job, and a file transmitting job.

The foregoing and/or other features and utilities of the present general inventive concept may also be achieved by providing a recording medium storing a program to execute an image forming method including connecting a portable storage medium to an image forming apparatus and selecting at least one file in the portable storage medium, and performing a job corresponding to the at least one selected file in response to the portable storage medium being disconnected from the image forming apparatus.

The foregoing and/or other features and utilities of the present general inventive concept may also be achieved by providing an image forming apparatus including a connector which is connectible with a portable storage medium, a user interface to display information regarding one or more files stored in the portable storage medium connected to the connector and receive a user selection of at least one of the files based on the displayed file information, a storage unit to copy the at least one selected file, and a controller to perform a job requested by the user with respect to the at least one selected file copied into the storage unit in response to the portable storage medium being disconnected from the connector.

The controller may convert the at least one selected file into job data in response to the portable storage medium being disconnected from the connector.

The user interface may output a message to request a disconnection of the portable storage medium prior to performing the job corresponding to the at least one selected file.

The user interface may output an error message in response to the portable storage medium not being disconnected from the connector after a predetermined time.

The portable storage medium may be at least one memory device connectible to the USB port, at least one memory card connectible to the memory slot, or a combination thereof.

The job may include at least one of a printing job, a faxing job, an emailing job, and a file transmitting job.

The foregoing and/or other features and utilities of the present general inventive concept may be achieved by providing a method of controlling an image forming apparatus, the method including receiving a job request corresponding to data recorded in a portable storage medium connected to the image forming apparatus, and performing the job request in response to the portable storage medium being disconnected from the image forming apparatus.

The method may further include outputting an alert in response to the portable storage medium not being disconnected from the image forming apparatus after a predetermined time.

The predetermined time may start after receiving the job request.

The alert may be visual, audible, or a combination thereof.

The foregoing and/or other features and utilities of the present general inventive concept may be achieved by providing a recording medium having recorded thereon a program to control an image forming apparatus to perform operations including receiving a job request corresponding to data recorded in a portable storage medium connected to the image forming apparatus, and performing the job request in response to the portable storage medium being disconnected from the image forming apparatus.

The foregoing and/or other features and utilities of the present general inventive concept may be achieved by providing an image forming apparatus including a detection circuit to detect that a requested job is based on data recorded on a portable storage medium connected to the image forming apparatus, and a delay circuit to delay performance of the requested job until after the portable storage medium is disconnected from the image forming apparatus.

The image forming apparatus may further include an alert circuit to output an alert in response to the portable storage medium not being disconnected after a predetermined time after the job is requested.

The image forming apparatus may further include a device to visually output the alert, a device to audibly output the alert, or a combination thereof.

The foregoing and/or other features and utilities of the present general inventive concept may be achieved by providing a method of controlling an apparatus, the method including delaying execution of a requested job based on data recorded on a portable storage medium until after the portable storage medium is disconnected from the apparatus.

Accordingly, the portable storage medium can be used more safely and conveniently.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a schematic view illustrating an image forming apparatus according to an exemplary embodiment of the present general inventive concept;

FIG. 2 is a flowchart illustrating an image forming method according to an exemplary embodiment of the present general inventive concept;

FIGS. 3 and 4 are flowcharts illustrating diverse examples of a detailed process of the image forming method of FIG. 2;

FIG. 5 is a block diagram illustrating an image forming apparatus according to an exemplary embodiment of the present general inventive concept; and

FIG. 6 is a detailed block diagram illustrating an image forming apparatus according to another embodiment of the present general inventive concept.

### DETAILED DESCRIPTION OF THE EMBODIMENTS

Reference will now be made in detail to various embodiments of the present general inventive concept, examples of which are illustrated in the accompanying drawings, wherein like reference numerals refer to like elements throughout. The embodiments are described below in order to explain the present general inventive concept by referring to the figures.

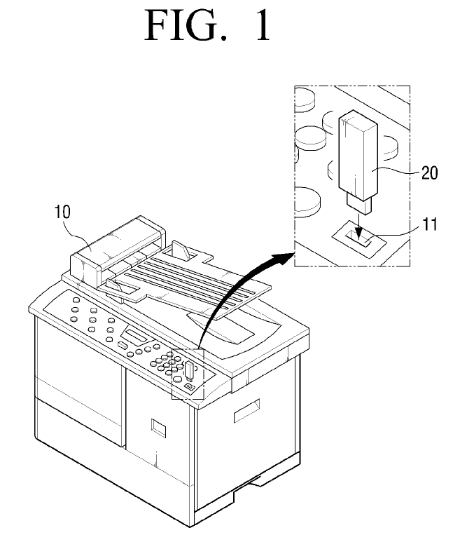

FIG. 1 is a view illustrating an image forming apparatus according to an exemplary embodiment of the present general inventive concept. Referring to FIG. 1, an image forming apparatus 10 may include a connector 11 which is connectible with a portable storage medium 20.

The portable storage medium 20 may be embodied by, for example, a memory card or a universal serial bus (USB) memory, and may also be embodied by various electronic devices which may have a hard memory and are connectible to the connector 11 through a connection such as a cable, for example, a camera, a laptop computer, a mobile phone, etc.

A user may connect the portable storage medium 20 to the image forming apparatus 10, select a file to be processed from files stored in the portable storage medium 20, and then input a command to perform a job corresponding to the file to the image forming apparatus 10.

In this example, the image forming apparatus 10 may read out the file from the portable storage medium 20 and copy the file into an internal memory of the image forming apparatus 10. Then, the image forming apparatus 10 may wait for the disconnection of the portable storage medium 20 from the image forming apparatus 10 and perform the job for the file after the disconnection. The job for the file may include operations such as, for example, printing, faxing, file transmitting, emailing, etc. As such, since the image forming apparatus 10 does not perform a job desired by a user until the portable storage medium 20 is disconnected from the image forming apparatus 10, it is possible to prevent a user from forgetting to disconnect the portable storage medium 20.

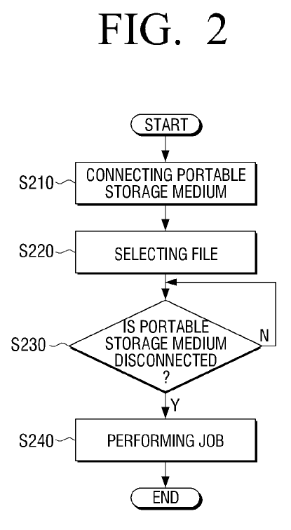

FIG. 2 is a flowchart illustrating an image forming method of operating the image forming apparatus 10 according to an exemplary embodiment of the present general inventive concept. Referring to FIG. 2, if a user connects the portable storage medium 20 to the image forming apparatus 10 in operation S210 and selects at least one of files stored in the portable storage medium 20 in operation S220, it may be determined whether the portable storage medium 20 is disconnected in operation S230.

If the portable storage medium 20 is not disconnected from the image forming apparatus 10, the image forming apparatus 10 may wait for the disconnection. On the other hand, if the portable storage medium 20 is disconnected from the image forming apparatus 10, a job requested by the user may be performed in operation S240. If the image forming apparatus 10 has only a printing function, the image forming apparatus 10 may be set to start the printing job in response to the portable storage medium 20 being disconnected from the image forming apparatus 10 without receiving an extra command from the user. If the image forming apparatus has diverse functions such as printing, emailing, faxing, file transmitting, etc., the image forming apparatus may selectively perform the job desired by the user.

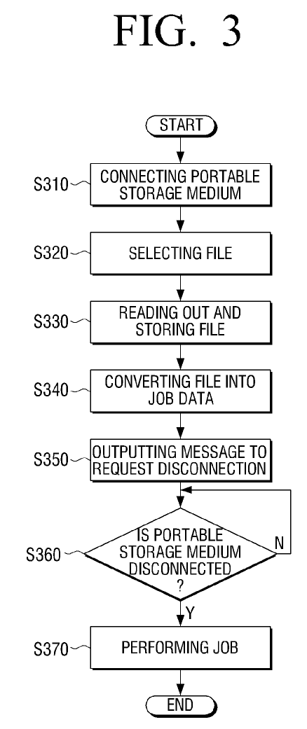

FIG. 3 is a flowchart illustrating an example of a detailed process of the image forming method of FIG. 2 according to an exemplary embodiment of the present general inventive concept.

Referring to FIG. 3, if the portable storage medium 20 is connected in operation S310 and a file to be processed is selected in operation S320, the image forming apparatus 10 may read out the file from the portable storage medium 20 and store it thereto in operation S330.

The read file may be converted into job data in operation S340. The job data refers to data of a format suitable for the job desired by the user. For example, if the user wishes to print the file, the file may be converted into printing data such as, for example, a bitmap image which is readable by a print engine controller. Similarly, if the user wishes to fax the file, the file may be converted into fax data, and if the user wishes to email or otherwise transmit the file, the file may be converted into data to which a header containing a destination address and a sender address or a tail is added.

With the read file converted into the job data, the image forming apparatus 10 may output a message to request the user to disconnect the portable storage medium 20 in operation S350. The message may be a visual message displayed on a display panel provided on the image forming apparatus 10, but the message is not limited to such a visual message. The message may be output in one or more various forms, such as a voice message through a speaker, an alert light or sound, and so on.

If the user disconnects the portable storage medium 20 from the image forming apparatus 10 at the request for disconnection in operation S360, the image forming apparatus 10 may perform a job desired by the user in operation S370. Selecting the job may be performed at the same time as operation S320, but the timing of the selection of the job is not limited thereto. The job may be selected at predetermined time, before or after selecting the file, and so on.

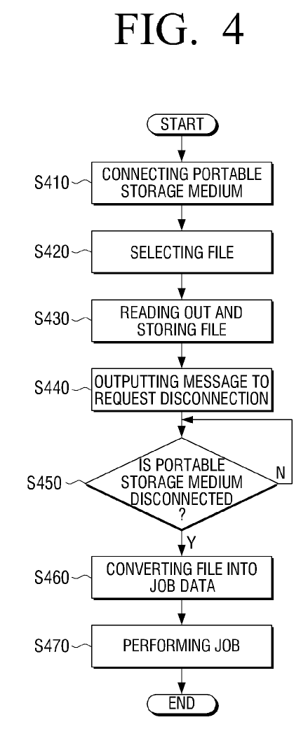

FIG. 4 is a flowchart illustrating another example of a detailed process of the image forming method of FIG. 2 according to an exemplary embodiment of the present general inventive concept. Referring to FIG. 4, if the portable storage medium 20 is connected in operation S410 and a file is selected in operation S420, the image forming apparatus 10 may read out the file from the portable storage medium 20 and store it thereto in operation S430. With the read file stored, the image forming apparatus 10 may output a message to request a disconnection in operation S440 and wait until the portable storage medium 20 is disconnected from the image forming apparatus 10.

If the portable storage medium 20 is disconnected in operation S450, the image forming apparatus may convert the file which has been copied thereto into job data in operation S460 and perform a corresponding job in operation S470. Unlike the method of FIG. 3, in the method of FIG. 4 the image forming apparatus 10 may only copy the file and not perform the converting operation until the portable storage medium 20 is disconnected.

As such, the order of operations of the image forming method may change depending on the characteristic and purpose of the image forming apparatus, and various operations may be deleted or added.

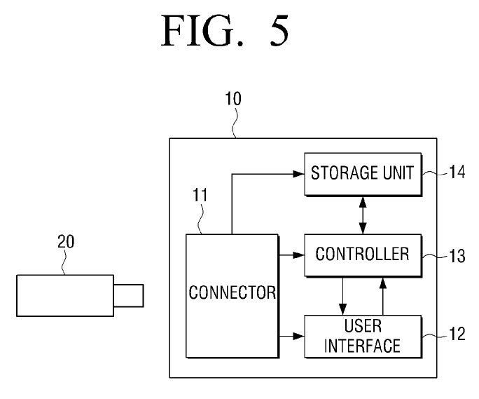

FIG. 5 is a block diagram illustrating the image forming apparatus 10 according to an exemplary embodiment of the present general inventive concept. Referring to FIG. 5, the image forming apparatus 10 may include the connector 11, a user interface 12, a controller 13, and a storage unit 14.

The connector 11 may be a component that is connectible with the portable storage medium 20. More specifically, the connector 11 may be, for example, a USB port to which a USB memory or a USB cable is connected, a memory slot into which a memory card is mounted, and so on. Also, a plurality of USB ports, or a plurality of memory slots, or a plurality of other similarly configured devices, may be provided.

The user interface 12 may display information about files stored in the mobile storage medium 20 in response to the mobile storage medium 20 being connected to the connector 11, so as to allow a user to select at least one of the files based on the file information. The user interface 12 may be implemented, for example, as having a display panel and/or a keypad, a sound output component, such as a speaker, or a combination of such configurations.

The controller 13 may control operations of the image forming apparatus 10 so as to perform a job corresponding to the file selected by a user after the portable storage medium 20 is disconnected from the connector 11. More specifically, if the portable storage medium 20 is connected to the connector 11 and a file is selected through the user interface 12, the controller 13 may read out the file and store it to the storage unit 14. In this state, the image forming apparatus may wait until the portable storage medium 20 is disconnected before performing the corresponding job.

In response to the portable storage medium 20 being disconnected, a job corresponding to the file selected and stored in the storage unit 14, such as printing, file transmitting, faxing, emailing, etc., may be performed. The selection of the job may be performed through the user interface 12, or by various other methods (for example, a default job may be set or a command to select a job may be received from an external host).

If the portable storage medium 20 remains connected to the connector 11, the controller 13 may control the user interface 12 to output a message requesting a disconnection. For example, the user interface 12 may output a message such as, “Disconnect the portable storage medium if you wish to continue the job”. Such a message may include visual and/or audio components.

The controller 13 may convert the selected file into data of a format suitable for the job, i.e., job data. The converting operation may be performed before or after the portable storage medium 20 is disconnected.

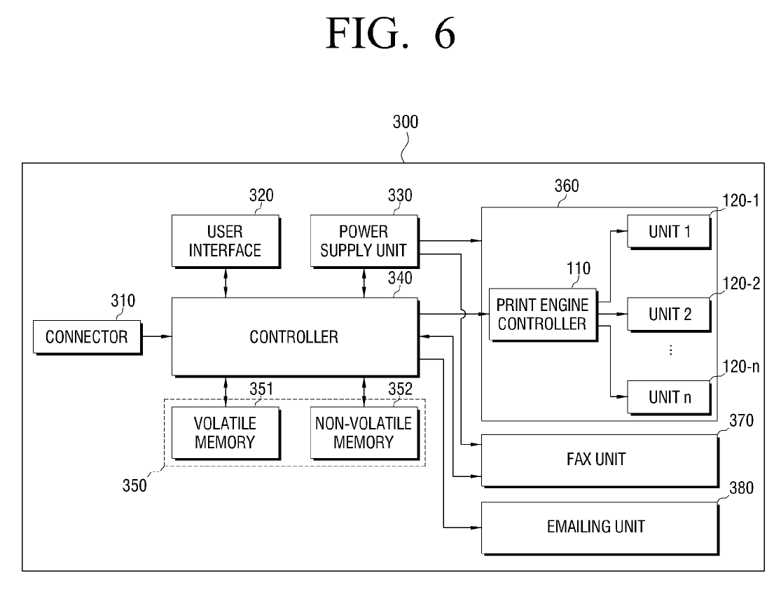

FIG. 6 is a detailed block diagram illustrating an image forming apparatus according to another embodiment of the present general inventive concept.

Referring to FIG. 6, an image forming apparatus 300 may include a connector 310, a user interface 320, a power supply unit 330, a controller 340, a storage unit 350, a printer unit 360, a fax unit 370, and an emailing unit 380. FIG. 6 illustrates a multifunction peripheral which may perform at least two functions such as, for example, printing, photocopying, faxing, etc. In the case of a printer, some components such as the fax unit 200 or the emailing unit 300 may be omitted. Although not shown, additional components such as a bus to exchange data between the components and a buffer to temporarily store data may be added. Similarly, various components may be omitted according to the type and/or function of the image forming apparatus 300.

In FIG. 6, the connector 310 may be connected with a USB memory, a memory card, and/or other memory devices by various methods.

The user interface 320 may be provided to receive various selecting commands from the user. The user interface 320 may include a display panel (not shown) and at least one button (not shown). As merely one example, the display panel may be realized as a touch screen. The user interface 320 may provide various user interface (UI) windows such that the user may input a selecting command by touching the UI window or manipulating the button provided on the user interface 320. The selecting command may set various functions provided by the image forming apparatus or set a mode change, pause, replay, etc. As described above, the user interface 320 may output a message to request a disconnection of the portable storage medium 20.

The power supply unit 330 may supply a power to respective components of the image forming apparatus 300. More specifically, the power supply unit 330 may receive a common alternating current (AC) power (AC_IN) and convert it into a direct current (DC) power of an electric potential suitable for respective components using an element such as a transformer, an inverter, a rectifier, etc., and output the DC power (DC_OUT).

The controller 340 may read out a file from the portable storage medium 20 connected to the image forming apparatus 300 through the connector 310 and store it to the storage unit 350.

As such, the storage unit 350 may be provided to copy and store a file from the portable storage medium 20. Herein, the copy may be a temporary copy. That is, if a job for the file is completed, the file may be deleted. Also, the storage unit 350 may store various information such as the specification of the image forming apparatus 300, current state, printing data, scan data, already-processed data, printing history information, etc., and various application programs used in the image forming apparatus 300 and an operating system.

The storage unit 350 may include a volatile memory 351 and a non-volatile memory 352. The volatile memory 351 may serve as a temporary storing space for the file to be used in the operation. As described above, the file copied from the portable storage medium 20 may be temporarily stored to the volatile memory 351 and may be discarded after a corresponding job is completed. The non-volatile memory 352 may store various data or programs in a non-volatile manner.

Although FIG. 6 illustrates a single volatile memory 351 and a single non-volatile memory 352, the number and size of such memories may vary depending on the characteristics of the image forming apparatus 300.

The controller 340 may control operations of the image forming apparatus 300 to perform a job corresponding to the file read out from the portable storage medium 20 in response to the portable storage medium 20 being disconnected. More specifically, in order to perform a printing job with respect to a selected file of the files copied into the storage unit 350 from the portable storage medium 20, the controller 340 may, for example, convert printing data into a bitmap image having values of “0” and “1” using a halftone table. The converting operation may be performed before or after the portable storage medium 20 is disconnected.

In response to the job data converting operation being completed, the controller 340 may provide data to the printer unit 360 to print the data on a print medium. The printer unit 360 may include a print engine controller 110 and a plurality of units 120-1˜120-n which may be operated to perform the printing job. In the case of a laser printing method, the units 120-1˜120-n may be, for example, a paper feeding unit, a charging unit, a laser scanning unit, a developing unit, a transfer unit, a fusing unit, and a paper discharging unit. In the case of an ink-jet printing method, the units 120-1˜120-n may be, for example, a paper feeding unit, an ink-jet printer head, an ink cartridge, and a paper discharging unit. The print engine controller 110 may control respective units 120-1˜120-n to perform the printing operation based on the bitmap image provided from the controller 340.

In order to perform a faxing job, the controller 340 may control the fax unit 370 to fax the file stored in the storage unit 350. Accordingly, the fax unit 370 may have access to a fax net and fax the file to a fax number selected by the user.

In order to perform an emailing job or a file transmitting job, the controller 340 may control the emailing unit 380 to transmit the file stored in the storage unit 350 or a mail attached to the file to a mail address selected by the user. The emailing unit 380 may include, for example, a network interface card (not shown) connectible to the Internet.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable code can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

While various embodiments of the present general inventive concept have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the present general inventive concept.

What is claimed is:

1. An image forming method of an image forming apparatus using a portable storage medium, the method comprising:
connecting the portable storage medium to the image forming apparatus;
selecting at least one file stored in the portable storage medium;
converting the at least one selected file into job data;
disconnecting the portable storage medium from the image forming apparatus; and
performing a job corresponding to the at least one selected file in response to the portable storage medium being disconnected from the image forming apparatus.

2. The image forming method as claimed in claim 1, further comprising:
copying the at least one selected file into a storage unit of the image forming apparatus;
wherein the performing of the job includes converting the at least one selected file into job data.

3. The image forming method as claimed in claim 1, further comprising:
outputting a message to request a disconnection of the portable storage medium prior to performing the job corresponding to the at least one selected file.

4. The image forming method as claimed in claim 1, further comprising:
displaying an error message in response to the portable storage medium not being disconnected from the image forming apparatus after a predetermined time.

5. The image forming method as claimed in claim 1, wherein the portable storage medium comprises at least one memory device connectible to a USB port of the image forming apparatus, at least one memory card connectible to a memory slot of the image forming apparatus, or a combination thereof.

6. The image forming method as claimed in claim 1, wherein the job comprises at least one of a printing job, a faxing job, an emailing job, and a file transmitting job.

7. A recording medium storing a program to execute an image forming method, the method comprising:
connecting a portable storage medium to an image forming apparatus and selecting at least one file stored in the portable storage medium; and
performing a job corresponding to the at least one selected file in response to the portable storage medium being disconnected from the image forming apparatus,
wherein the job comprises at least one of a printing job, a faxing job, an emailing job, and a file transmitting job.

8. An image forming apparatus comprising:
a connector which is connectible with a portable storage medium;
a user interface to display information regarding one or more files stored in the portable storage medium connected to the connector and receive a user selection of at least one of the files based on the displayed file information;
a storage unit to copy the at least one selected file; and
a controller to perform a job requested by the user with respect to the at least one selected file copied into the storage unit in response to the portable storage medium being disconnected from the connector,
wherein the controller converts the at least one selected file into job data in response to the portable storage medium being disconnected from the connector.

9. The image forming apparatus as claimed in claim 8, wherein the user interface outputs a message to request a disconnection of the portable storage medium prior to performing the job corresponding to the at least one selected file.

10. The image forming apparatus as claimed in claim 8, wherein the user interface outputs an error message in response to the portable storage medium not being disconnected from the connector after a predetermined time.

11. The image forming apparatus as claimed in claim 8, wherein the connector is a USB port, a memory slot, or a combination thereof; and
the portable storage medium is at least one memory device connectible to the USB port, at least one memory card connectible to the memory slot, or a combination thereof.

12. The image forming apparatus as claimed in claim 8, wherein the job comprises at least one of a printing job, a faxing job, an emailing job, and a file transmitting job.

13. A method of controlling an image forming apparatus, the method comprising:
receiving a job request corresponding to data recorded in a portable storage medium connected to the image forming apparatus;
outputting an alert in response to the portable storage medium not being disconnected from the image forming apparatus after a predetermined time; and
performing the job request in response to the portable storage medium being disconnected from the image forming apparatus.

14. The method of claim 13, wherein the predetermined time starts after receiving the job request.

15. An image forming apparatus comprising:
a detection circuit to detect that a requested job is based on data recorded on a portable storage medium connected to the image forming apparatus;
a delay circuit to delay performance of the requested job until after the portable storage medium is disconnected from the image forming apparatus;
an alert circuit to output an alert in response to the portable storage medium not being disconnected after a predetermined time after the job is requested; and
a device to visually output the alert, a device to audibly output the alert, or a combination thereof.
